(19) United States
(12) Patent Application Publication
(10) Pub. No.: US 2009/0061969 A1
(43) Pub. Date: Mar. 5, 2009

(54) COMBINE HARVESTER WITH A DEVICE FOR SEPARATING OUT FOREIGN OBJECTS

(76) Inventors: Walter Foegeling, Herzebrock (DE); Dirk Speckamp, Hamm/Westf. (DE); Hubert Korte, Ostbevern (DE); Bernhard Aerdker, Warendorf (DE)

Correspondence Address: MICHAEL J. STRIKER, 103 EAST NECK ROAD, HUNTINGTON, NY, 11743, US

(21) Appl. No.: 12/202,679

(22) Filed: Sep. 2, 2008

(30) Foreign Application Priority Data
Sep. 4, 2007 (DE) 10 2007 041 715.4

(51) Int. Cl. A01D 41/12; A01D 75/18

(52) U.S. Cl. 460/105

(57) ABSTRACT

A combine harvester, has a device for separating out foreign objects, a feed rake with at least one tension mechanism, which is located in a channel and is redirected via at least one upper and one lower tension mechanism guide, at least one foreign-object capture basin, foreign object separating elements that extend through the tension mechanism and assigned to at least the upper tension mechanism guide, the foreign object capture basin is located in the engagement region of the foreign object separating elements.

### CROSS-REFERENCE TO A RELATED APPLICATION

The invention described and claimed hereinbelow is also described in German Patent Application DE 10 2007 041 715.4 filed on Sep. 4, 2007. This German Patent Application, whose subject matter is incorporated here by reference, provides the basis for a claim of priority of invention under 35 U.S.C. 119(a)-(d).

### BACKGROUND OF THE INVENTION

The present invention relates to a combine harvester.

Publication DE 31 35 992 A1 makes known a combine harvester of this type with a device for separating out objects embedded in the crop material. The device is composed of a foreign object capture basin, which is located below the feed rake and approximately half-way between the lower and upper tension mechanism guides. Several tension chains that extend in parallel are used as tension mechanisms, the tension chains being connected at least partially with each other via conveyor strips that are screwed in place transversely to the direction of conveyance. The crop material that is picked up by a crop material pick-up device, e.g., a grain-cutting device, is conveyed via the conveyor strips in the lower floor region of the feed rake to the crop material processing elements, e.g., a threshing mechanism, located in the combine harvester.

A sensing device, which serves to press foreign objects—stones, in particular—located in the crop mat into the foreign object capture basin, is located above the foreign object capture basin, between the lower and upper spans of the tension mechanism. The sensing device includes a guiding device, which extends essentially across the entire width of the feed rake and in the direction of the feed rake base, and which is pressed in the direction of the crop mat via the force of a spring.

The tension mechanism is also guided by a suitably designed surface of the guiding device. If stones are located on or in the crop mat, they will be pressed on the guiding device due to its inclined position and in the direction of the foreign object capture basin, thereby being separated out of the crop mat. The disadvantage of a known combine harvester of this type is the fact that the device may only act on foreign objects that are located above the tension mechanism and, therefore, above the crop mat. Small foreign objects, in particular, that are located in the crop mat and do not extend over the conveyor gap between the feed rake bottom and the tension mechanism may not be separated out using a device of this type. They are therefore conveyed into the crop material processing elements of the combine harvester, where they may damage the combine harvester. It is also disadvantageous that the device is located approximately in the center of the feed rake, making it difficult to access due to the design of the feed rake. As a result, a great deal of time is required to assemble the device and perform any necessary repairs on it.

Publication DE 26 00 833 A1 makes known a combine harvester with a device for separating out foreign objects, a similar design of which is currently used in a number of combine harvesters in practical application. A stone capture basin is located between the end of the tension mechanism located in the feed rake and the engagement region of a cylinder, into which foreign objects—usually stones—located in the crop mat fall, due to their weight. If the stone capture basin is already filled with foreign objects, a mechanism is provided that serves to empty the stone capture basin. The disadvantage of the known device is that, due to the position of the stone capture basin, the size and, therefore, the possible wraparound angle of the concaves surrounding the cylinder are limited, thereby limiting the potential output of the combine harvester. It is also disadvantageous that foreign objects located in or on the crop mat are not always able to pass through the crop mat, due to their light weight. They are therefore conveyed through the crop material processing process of the combine harvester and may cause damage.

### SUMMARY OF THE INVENTION

The object of the present invention is to avoid the disadvantages of the related art described above, and to provide, in particular, a combine harvester of the type such that foreign objects that are located in the crop material are separated out reliably and effectively.

In keeping with these objects and with others which will become apparent hereinafter, one feature of the present invention recites, briefly stated, in a combine harvester with a device for separating out foreign objects, and that includes a feed rake with at least one tension mechanism, which is located in a channel and is redirected via at least one upper and one lower tension mechanism guide, and that includes at least one foreign-object capture basin, wherein foreign object separating elements that extend through tension mechanism are assigned to at least upper tension mechanism guide, and wherein foreign object capture basin is located in the engagement region of foreign object separating elements.

Given that, with a combine harvester with a device for separating out foreign objects that includes a feed rake with at least one tension mechanism, which is located in a channel and is redirected via at least one upper and one lower tension mechanism guide, and that includes at least one foreign-object capture basin, with foreign object-separating elements that extend through tension mechanism being assigned, at the least, to the upper tension mechanism, and the foreign object capture basin being located in the engagement region of the foreign object separating elements, foreign objects that are located in or on the crop mat are actively captured by the foreign object separating elements and are conveyed into the foreign object capture basin. Even when a crop mat is dense, it is thereby ensured that foreign objects do not enter the crop material processing elements of the combine harvester, having been separated out beforehand.

With an advantageous refinement of the present invention, the foreign object capture basin is located upstream of the upper tension mechanism guide, as viewed in the direction of crop material flow. This offers the advantage, in particular, that the installation space located between the tension mechanism and the threshing part is available for a larger concave, thereby increasing the wraparound angle of the concaves around the threshing devices and increasing the output of the combine harvester. A further advantage of a design of the foreign object capture basin of this type results from the fact that sufficient installation space is available at the position below the feed rake, thereby making it possible to design the foreign object capture basin with a large volume and extending the time intervals between which the basin must be emptied.

A refinement of the present invention is characterized by the fact that the foreign object separating elements are supported such that they may rotate around the rotation axis of the upper tension mechanism guide and are drivable together with the tension mechanism. This results in a compact and simple design of the device, without the need to provide a special drive mechanism.

To prevent the foreign object separating elements from engaging too strongly in the crop mat and, in the worst case, conveying crop material around the upper tension mechanism guide and back into the feed rake, it is provided with an advantageous refinement of the inventive device that the foreign object separating elements are supported in an eccentric manner and such that they may rotate around the rotation axis of the upper tension mechanism, thereby ensuring that they come in contact with the crop mat only in the region of the foreign object capture basin, and otherwise lie behind the engagement region of the tension mechanism.

The foreign object separating elements are advantageously designed as strips that extend through the tension mechanism, thereby ensuring that the engagement in the crop mat covers a large surface area and that the foreign objects are effectively separated out.

As an alternative, the foreign object separating elements are designed as fingers that extend through the tension mechanism, thereby resulting in a simple design of the device that is optimized in terms of weight.

It is also possible to use a combination of strips and fingers as the foreign object separating elements.

With an advantageous refinement of the present invention, the diameter of the circular, outer trajectory of the foreign object separating elements is greater than the outer diameter of the upper tension mechanism guide. Due to a design of this type, the foreign object separating elements not only effectively separate out the foreign objects located in the crop mat, they also serve simultaneously as an accelerating device for the crop mat, via which the crop material is accelerated and conveyed to the threshing part in a thin, even layer. The advantages and mode of operation of an accelerating device that is operatively connected with the upper tension mechanism guide are described in a European patent application submitted by the applicant, with publication number EP 1 733 607 A1, the features of which are incorporated via reference in this application.

Advantageously, at least one wall of the foreign object capture basin is mountable on the channel in a swiveling manner, thereby ensuring that the foreign object capture basin may be emptied easily and quickly.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic side view of a self-propelled combine harvester, and

FIG. 2 shows a schematic, enlarged side view of a feed rake according to the present invention.

### DESCRIPTION OF THE PREFERRED EMBODIMENTS

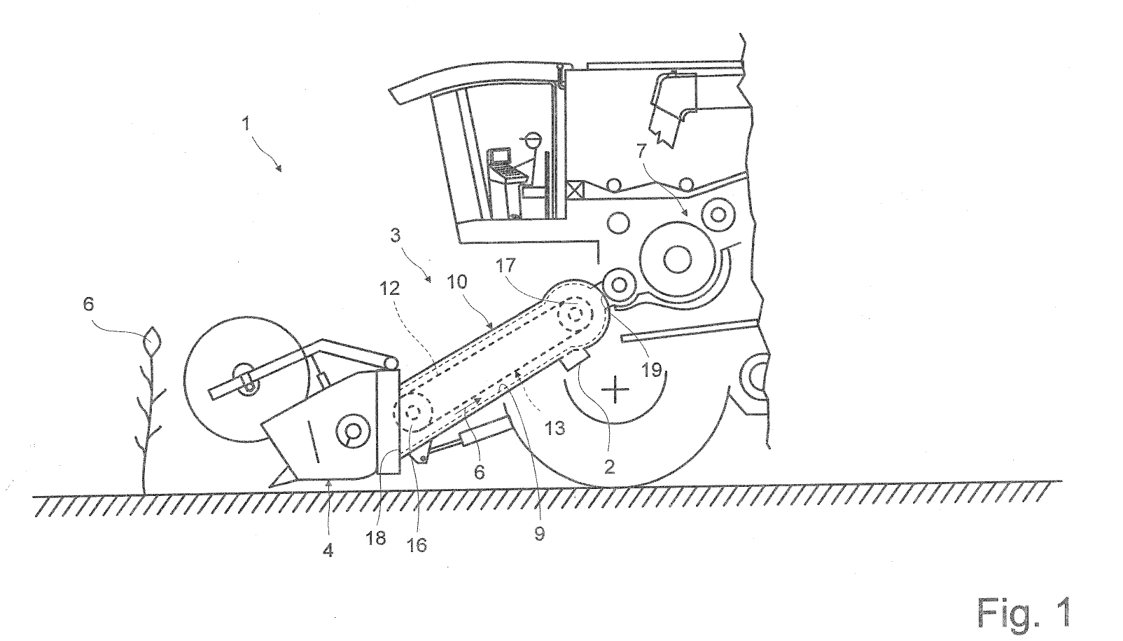

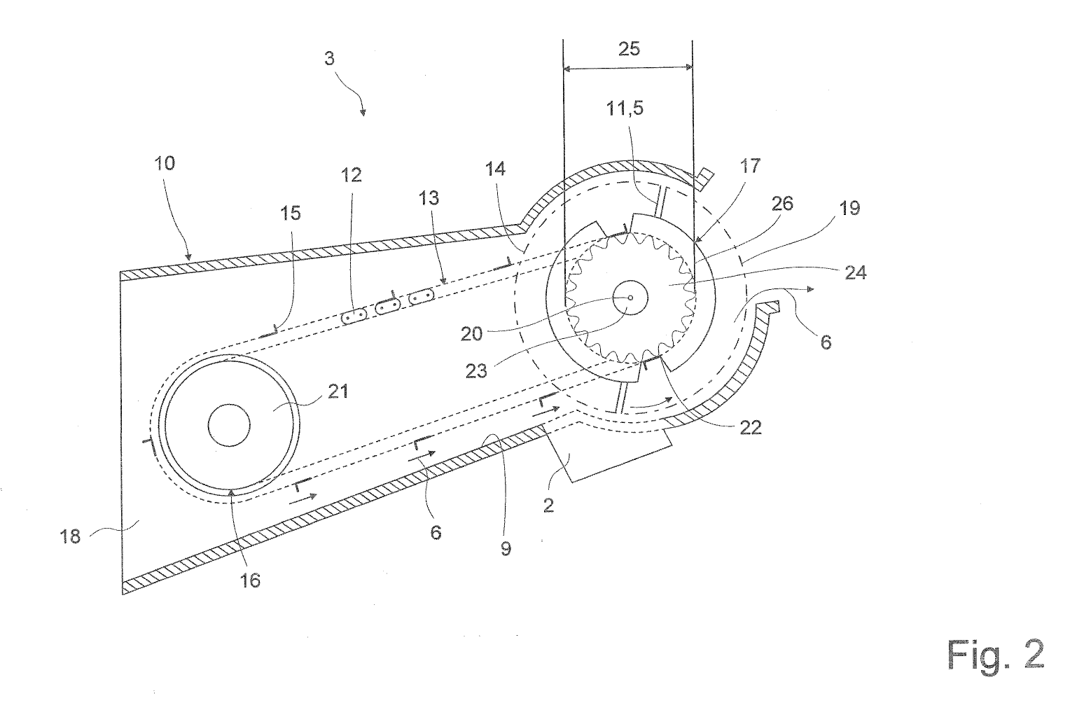

An agricultural harvesting machine configured as a self-propelled combine harvester I is shown in a schematic side view in FIG. 1, on feed rake 3 of which a front attachment designed as header 4 is located. The front attachment may also be designed as a corn picker or the like, of course. Crop material 6 that has been cut by header 4 is conveyed into feed rake 3 at an inlet opening 18. Feed rake 3 now conveys crop material 6 further to its outlet opening 19, where it is forwarded to a threshing part 7 located in the combine harvester housing. A large number of tension mechanisms 13 designed as chains 12 is located in channel 10 of feed rake 3 to convey crop material 6. Tension mechanisms 13 are driven in a continual manner around a lower tension mechanism guide 16 and an upper tension mechanism guide 17. Crop material 6 is conveyed between tension mechanism 13 and bottom 9 of channel 10 in an undershot manner. A foreign object capture basin 2 is located in the region of upper tension mechanism guide 17, which will be described in greater detail with reference to FIG. 2.

FIG. 2 shows an enlarged side view of inventive feed rake 3. It includes two tension mechanisms 13 designed as endless chains 12 and which are interconnected via driving strips 15. Chains 12 are redirected via a lower tension mechanism guide 16 and an upper tension mechanism guide 17. Lower tension mechanism guide 16 is rotatably supported in the region of inlet opening 18 of channel 10 facing header 4, and upper tension mechanism guide 17 is rotatably supported in the region of outlet opening 19 of channel 10 facing threshing part 7. Driving strips 15 push crop material 6 that enters inlet opening 18 across floor 9 of channel 10, to outlet opening 19. Feed rake 3 is height-adjustable around rotation axis 20 of upper tension mechanism guide 17.

Tension mechanism 13 is driven via a sprocket 24 located on upper tension mechanism guide 17. Upper tension mechanism guide 17 therefore serves simultaneously as drive shaft 23. Lower tension mechanism guide 16 is designed as cylinder 21, so it only guides and redirects tension mechanism 13. Upper tension mechanism guide 17 also includes a cylinder 26, the diameter of which is greater than diameter 25 of sprocket 24 and determines the deflection radius of tension mechanism 13. Cylinder 26 includes grooves 22, the separation of which corresponds to the separation of driving strips 15 on pulling means 13. In addition, foreign object separating elements 11 designed as fingers 5 are located on the outer circumference of cylinder 26 and extend through tension mechanism 13 as it rotates.

Floor 9 of channel 10 is open in the region of the engagement of foreign object separating elements 11, and a foreign object capture basin 2 is located there. Foreign object capture basin 2 is mounted on the channel so that it may be emptied using a swivel mechanism that is not shown here.

If foreign objects, e.g., stones, are located in the crop material mat, they are captured in the region of upper pulling means guide 17 by foreign object separating elements 11, which are rotating in the counterclockwise direction around rotation axis 20, and they are pushed into foreign object capture basin 2. This applies for large foreign objects as well as small foreign objects, since they undergo acceleration due to the large diameter of trajectory 14 of foreign object separating elements 2 and even pass through very dense crop mats.

The large diameter of trajectory 14 of foreign object separating elements 11 also has the advantage that crop material 6 is accelerated and is therefore conveyed to the threshing part as a thin-layered, even crop mat.

It will be understood that each of the elements described above, or two or more together, may also find a useful application in other types of constructions differing from the types described above.

While the invention has been illustrated and described as embodied in a combine harvester with a device for separating out foreign objects, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A combine harvester, comprising a device for separating out foreign objects; a feed rake with at least one tension mechanism, which is located in a channel and is redirected via at least one upper and one lower tension mechanism guide; at least one foreign-object capture basin; foreign object separating elements that extend through said tension mechanism and assigned to at least said upper tension mechanism guide; said foreign object capture basin is located in the engagement region of said foreign object separating elements.

2. A combine harvester as defined in claim 1, wherein said foreign object capture basin is located upstream of said upper tension mechanism, as viewed in a direction of crop material flow.

3. A combine harvester as defined in claim 1, wherein said foreign object separating elements are supported such that they are rotatable around a rotation axis of said upper tension mechanism guide and are drivable together with said tension mechanism.

4. A combine harvester as defined in claim 1 wherein said foreign object separating elements are supported in an eccentric manner and such that they are rotatable around a rotation axis of said upper tension mechanism guide and are drivable together with said tension mechanism.

5. A combine harvester as defined in claim 1, wherein said foreign object separating elements are configured as strips that extend through said tension mechanism.

6. A combine harvester as defined in claim 1, wherein said foreign object separating elements are configured as fingers that extend through said tension mechanism.

7. A combine harvester as defined in claim 1, wherein said foreign object separating elements have a circular outer trajectory with a diameter which is greater than an outer diameter of said upper tension mechanism guide.

8. A combine harvester as defined in claim 1, wherein said foreign object capture basin has at least one wall mountable on said channel in a swiveling manner.
